(19) United States
(12) Patent Application Publication
(10) Pub. No.: US 2004/0172282 A1
(43) Pub. Date: Sep. 2, 2004

(54) Best healthcare system

(76) Inventor: Anuthep Benja-Athon, New York, NY (US)

Correspondence Address: ANUTHEP BENJA-ATHON, M.D., Rehabilitation Medicine, Acupuncture Physical Therapy, 210 East 36th Street, New York, NY, 10016, US

(21) Appl. No.: 10/298,100

(22) Filed: Nov. 18, 2002

(51) Int. Cl. G06F 17/60

(52) U.S. Cl. 705/2

(57) ABSTRACT

A method and means for solving American healthcare crisis wherein the consumers, individual, employer, company and government buyers of healthcare products and services contribute and pool their resources for compensating physicians and healthcare professionals into a healthcare-purchasing cooperative or healthcare-purchasing cooperatives. These financial resources including performance-related incentives are owned, managed and operated by the cooperative(s) which utilizes the resources to optimally benefit aforementioned parties. Moreover, physicians and healthcare professionals are facilitated and encouraged to optimally provide the best healthcare goods and services in return for proportionate and adjustable compensations and incentives based on the utilizations of goods and services, dispensations, efficiency and outcomes of services, performance, merits and ranking of the physicians or healthcare professionals.

### FIELD OF INVENTION

The solution to the current American healthcare care crisis.

### BACKGROUND OF THE INVENTION

In the current American healthcare system, patients, employers, companies and the government face increasing healthcare and business costs, out-of-pocket expenses and premiums at alarming rates of about 15%-27%. Facing the crisis, all Americans particularly seniors and the 41.2 million uninsured endure untold suffering, indignity, physical and psychological pain, overdose on drugs, receive unnecessary or ineffective treatments and procedures, and a lowered living standard. The business of medicine has transformed patients, pills, procedures and premiums into commodities. The practice of medicine has become a frustrating struggle for the physicians and healthcare professionals. Hundreds of millions of physician hours are wasted every year because physicians are inundated with trade-related paperwork and choirs. There is no solution to the current healthcare woes.

U.S. Pat. No. 6,132,218 entitled Images for Communication of Medical Information in Computer was granted to this applicant on Oct. 17, 2000 representing this applicant's continual quest to improve the quality of healthcare.

The first objective of the present invention is to provide the best healthcare system in the world.

The second objective of the present invention is to solve the current healthcare crisis exemplified by the above.

The third objective of the present invention is provide the best method and means for providing and delivering the best healthcare at more affordable costs to the healthcare consumers and buyers.

The fourth objective of the present invention is to provide the universal accessibility to the best, uniform and equitable healthcare for all Americans including said uninsured and underinsured and people living in other countries.

The fifth objective of the present invention is to lead to many major milestone achievements in healthcare and medicine.

### SUMMARY OF THE INVENTION

There is no solution to the current healthcare crisis affecting all Americans. The healthcare costs to people, companies and government are escalating while the healthcare quality is deteriorating.

The present invention is a method and means for solving American healthcare crisis wherein the consumers, individual, employer, company and government buyers of healthcare products and services contribute and pool their resource means for compensating physicians and healthcare professionals into a healthcare-purchasing cooperative or healthcare-purchasing cooperatives. These financial resources including performance-related incentives are owned, managed and operated by the cooperative(s) which utilizes said financial resources and incentives to optimally benefit aforementioned parties. The healthcare-service productivity and creativity of physicians and healthcare professionals are maximized. Moreover, based on the utilizations of goods and services, dispensations, efficiency and outcomes of services, performance, merits and ranking of the physicians or healthcare professionals relative to their peers, physicians and healthcare professionals are facilitated and encouraged to optimally provide the best healthcare goods and services in return for proportionate and adjustable compensations and incentives.

### PREFERRED EMBODIMENTS OF THE INVENTION

The present invention is a method and means for solving a healthcare crisis particularly American healthcare crisis. In fact, the present invention creates and provides the best healthcare system in the world. In the present invention, consumers such as, patients, and individual, employer, company and government buyers of healthcare products and services and the physicians and healthcare professionals form a check-and-balance system of healthcare wherein said parties are responsive to each other healthcare and financial needs. Said parties mutually benefit from each other.

In the present invention, consumers and individual, employer, company and government buyers—American and foreign—of healthcare goods and services contribute their resources such as money and incentives into a pool or pools of money and incentives which are to be used to pay and compensate for the healthcare goods and services being rendered by physicians and healthcare in America and other countries. Said pool or pools of money and incentives are managed and administered by a healthcare-purchasing cooperative or healthcare purchasing cooperatives in America and other countries wherein said resources can be managed, allocated, renewed, invested, used for paying said goods and services. Said resources are fully owned and managed by said consumers and individual, employer, company and government buyers until such a time when a portion of said resources are paid out as compensations to physicians and healthcare professionals supra. The management and administering of the assets and account payables in said pools are the responsibility of the board of directors or governors and officers responsible to said consumers and individual, employer, company and government buyers and owners and physicians and healthcare professionals. Said cooperatives can be listed in the stock markets such as the New York Stock Exchange and are publicly traded.

The present invention further provides the method and means for optimally utilized said financial resources in return for optimal healthcare goods and services being provided and rendered to said consumers and individual, employer, company and government buyers and owners of said financial resources by said physicians and healthcare professionals.

In this check-and-balance business-healthcare system, all people including the uninsured and people from other countries have access to the optimal and best healthcare at the most affordable and nominal costs. Moreover, the costs to an individual consumer or buyer are based various financial circumstances and settings such as, but not limited to, incomes, ability to pay, standards of living, number of persons in a household or a company. From the standpoint of the physicians and healthcare professionals, all are participants of said system without discrimination and regardless of affiliations.

A computer system comprises computer softwares comprising programs and utilizes the Internet and World Wide Web adaptable to unite and coordinate the efforts and utilization of all financial, human and technological resources of said consumers, individual, employer, company and government buyers and owners, corporation, physicians and healthcare professionals. For example, said programs have the ability to record, track, analyze and correlate the dispensations, utilizations, allocations and administration of said financial resources and healthcare goods and services by said parties; the performance, efficiency, treatment and preventive medicine means, modes and positive and negative outcomes relating to a physician, a healthcare professional, a group of physicians or healthcare professionals or a network of physicians or healthcare professionals; compare and analyze said information and data among said parties, cohorts and peers, etc.

In other words, said softwares and programs can provide information and data including, but not limited to, analyses, extrapolations and projections of ways and means said consumers and buyers utilize said financial, human and healthcare resources, the productivity of said physicians and healthcare professionals and their performance, efficiency and proficiency relative to those of their peers in absolute and relative terms. As a result, said managements and allocations and compensations can be optimally effected thereby keeping costs at the lowest while maximizing and optimizing services and productivity of all parties.

For example, said computer programs and softwares can sort and rank physicians and healthcare professionals based on the above data. For example, in pain specialty in a given geographic location, say, New York City or Washington, D.C., for example, a group of physicians can be sorted and ranked leading to variable accessibility and visibility on the computer screens being viewed by any and all consumers and buyers in New York City, Washington, D.C. or any other locations throughout the world. In other words, the more proficient and wiser a physician in utilizing said financial resources benefiting said consumers, buyers and cooperatives while providing the most optimal healthcare services to said parties the more patients and compensations said physician gets. Said physician then can propagate his skills and knowledge to others. On the contrary, the lesser proficient and less wise physician under said circumstances and settings will have less patients and receive less compensations.

Based on the above sorting, ranking and data, said computer program proportionately compensates every physician or healthcare professional. In other words, for example, said programs have the ability to use said information and data to determine and adjustable variable amounts of compensations based on said factors such as, but not limited to, dispensations, utilizations, allocations and administration, performance, efficiency, merits, treatment and preventive medicine means, modes and positive and negative outcomes of a physician, a healthcare professional, a group of physicians or a group healthcare professionals. Of course, overhead costs per geographic location are incorporated into said data such as the rent and employee wages in New York City versus those in Fairbanks, Ak.

A simplified example of utilizations based on said incentive approach is a sample case in diabetes. If a national norm for an established diabetic patient's visit to an endocrinologist's office is three visits per month at a cost of $X per month. Various extenuated factors are entered and considered by said computer program and physician peers, the same endocrinologist may be compensated by said cooperative or cooperatives for the same amounts covering only three visits for all total visits greater than three per month for a said given patient. On the contrary, the same endocrinologist will have highest ranking and visibility in the computer search and on the computer screen meaning greater access by patients, respectively, if same is able to consistently and optimally keep average patients' visit less than the national or international norm. However, the disincentive is applied to same if patient(s) of same ends up seeing other endocrinologist(s) or developed diabetic-related complications or emergencies necessitating more healthcare.

Another simple example is the arthroscopic surgery for arthritic knee, useless or ineffective devices, or expensive drugs in lieu of cheaper drugs of same indication and efficacy. The utilizations and dispensations of these goods and services resulted in no or lesser compensations by the cooperatives to all parties involved. If consumers so choose to have useless or ineffective, said consumers will need to pay out of pocket.

Said ranking, sorting, extrapolations and results are continually and perpetually processed and made available to said parties by said computer programs and softwares and via the Internet or World Wide Web.

The present invention eliminates or drastically reduces tons of unnecessary and useless paperwork including correspondence with various third-party payers which physicians and healthcare professionals are subjugated to by the current healthcare system. As a result, the healthcare-service productivity of physicians and healthcare professionals are maximized. Consequently, hundreds of millions of priceless physician and healthcare professional hours saved by the present invention every year can be used to improve the healthcare system, the advancement of healthcare and medicine and serve humanity.

Although the preferred embodiments have been described, it will be appreciated by those skilled in business, sciences and medicine that variations, additions and adaptations to the present invention can be had without departing from the spirit of the invention and the scope of the claims.

1. A means for solving a healthcare crisis wherein the consumers, individual, employer, company and government buyers of healthcare products and services contribute and pool said consumers' and buyers' resource means for compensating physicians and healthcare professionals into a healthcare-purchasing cooperative or healthcare-purchasing cooperatives wherein said resource means are owned and managed by said cooperative or cooperatives and are utilized to optimally benefit said consumers, buyers, physicians and healthcare professionals, wherein physicians and healthcare professionals optimally provide the best healthcare goods and services to said consumers and buyers in return for proportionate and adjustable compensations based on the utilizations of goods and services by said consumers, dispensations, efficiency and outcomes of services, performance, merits and ranking of said physicians or healthcare professionals and wherein said physicians' and healthcare professionals' healthcare-service productivity is maximized comprises:
a healthcare-purchasing cooperative comprising pooled healthcare-consumers' and healthcare-buyers' resource means for compensating physicians and healthcare professionals;
said healthcare-purchasing cooperatives comprising pooled healthcare-consumers' and healthcare buyers' resource means for compensating physicians and healthcare professionals;
a management means for renewing, managing, allocating, disbursing and investing said resource means to meet needs, requirements and obligations of said consumers, buyers, physicians and healthcare professionals;
a computer program means for collecting, tracking, recording, sorting and analyzing the dispensations and utilizations of healthcare goods and services;
a computer program means for collecting, recording, sorting and analyzing the outcomes of said healthcare goods and services;
a computer program means for collecting, recording, sorting and analyzing said dispensations, utilizations and outcomes relate to a physician or healthcare professional;
a computer program means for collecting, recording, sorting and analyzing said dispensations, utilizations and outcomes relate to a physician or healthcare professional relative to cohort physicians or healthcare professionals;
a computer program means for ranking a physician or healthcare professional relative to the peers as a function of said dispensations, utilizations, performance, efficiency, treatment and preventive medicine means, modes and outcomes;
a computer program means for sorting physicians or healthcare professionals based on said dispensations, utilizations, performance, efficiency, treatment and preventive medicine means, modes and outcomes;
a computer program means for facilitating the access of consumers, buyers and healthcare-purchasing cooperatives to a physician or healthcare professional based on ranking and sorting as a function of said dispensations, utilizations, performance, merits, efficiency, treatment and preventive medicine means, modes and outcomes;
a computer program means for proportionately compensating a physician or healthcare professional based on said consumers' utilizations of said goods and services, physician's or healthcare professional's dispensations of said goods and services and said data relating to dispensations, utilizations, performance, merits, efficiency, treatment and preventive medicine means, modes and outcomes;
a computer program means for adjustably compensating a physician or healthcare professional based on said consumers' utilizations of said goods and services, physician's or healthcare professional's dispensations of said goods and services and said data relating to dispensations, utilizations, performance, merits, efficiency, treatment and preventive medicine means, modes and outcomes; and
the computer and Internet or World Wide Web means for linking said consumers, buyers, physicians and healthcare professionals.

2. A means for reducing American healthcare costs, optimizing the deliveries and utilizations of healthcare resources and healthcare outcomes for Americans wherein the consumers, individual, employer, company and government buyers of healthcare products and services contribute and pool said consumers' and buyers' resource means for compensating physicians and healthcare professionals into a healthcare-purchasing cooperative or healthcare-purchasing cooperatives, wherein said resource means are owned, managed and administered by said cooperative or cooperatives and are utilized to optimally benefit said consumers, buyers, physicians and healthcare professionals, wherein physicians and healthcare professionals optimally concentrate on providing the best healthcare goods and services to said consumers and buyers in return for proportionate and adjustable compensations based on the utilizations of goods and services by said consumers, and said physician's or healthcare professional's dispensations, utilizations, performance, merits, efficiency, treatment and preventive medicine means, modes and outcomes and wherein said physicians' and healthcare professionals' healthcare-service productivity is maximized comprises:
a healthcare-purchasing cooperative comprising pooled healthcare-consumers' and healthcare-buyers' resource means for compensating physicians and healthcare professionals;
said healthcare-purchasing cooperatives comprising pooled healthcare-consumers' and healthcare buyers' resource means for compensating physicians and healthcare professionals;
a management means for renewing, managing, allocating, disbursing and investing said resource means to meet needs, requirements and obligations of said consumers, buyers, physicians and healthcare professionals;
a computer program means for collecting, tracking, recording, sorting and analyzing the dispensations and utilizations of healthcare goods and services;
a computer program means for collecting, recording, sorting and analyzing the outcomes of said healthcare goods and services;
a computer program means for collecting, recording, sorting and analyzing said dispensations, utilizations and outcomes relate to a physician or healthcare professional;
a computer program means for collecting, recording, sorting and analyzing said dispensations, utilizations and outcomes relate to a physician or healthcare professional relative to cohort physicians or healthcare professionals;
a computer program means for ranking a physician or healthcare professional relative to the peers as a function of said dispensations, utilizations, performance, efficiency, treatment and preventive medicine means, modes and outcomes;
a computer program means for sorting physicians or healthcare professionals based on said dispensations, utilizations, performance, efficiency, treatment and preventive medicine means, modes and outcomes;
a computer program means for facilitating the access of consumers, buyers and healthcare-purchasing cooperatives to a physician or healthcare professional based on ranking and sorting as a function of said dispensations, utilizations, performance, merits, efficiency, treatment and preventive medicine means, modes and outcomes;
a computer program means for proportionately compensating a physician or healthcare professional based on said consumers' utilizations of said goods and services, physician's or healthcare professional's dispensations of said goods and services and said data relating to dispensations, utilizations, performance, merits, efficiency, treatment and preventive medicine means, modes and outcomes;
a computer program means for adjustably compensating a physician or healthcare professional based on said consumers' utilizations of said goods and services, physician's or healthcare professional's dispensations of said goods and services and said data relating to dispensations, utilizations, performance, merits, efficiency, treatment and preventive medicine means, modes and outcomes; and
the computer and Internet or World Wide Web means for linking said consumers, buyers, physicians and healthcare professionals.

3. A method of reducing American healthcare costs, optimizing the deliveries and utilizations of healthcare resources and healthcare outcomes for all Americans including the uninsured and citizens of other countries whereby the consumers, individual, employer, company and government buyers of healthcare products and services contribute and pool said consumers' and buyers' resource means for compensating American and international physicians and healthcare professionals into a healthcare-purchasing cooperative or healthcare-purchasing cooperatives comprises:
a process of owning, managing and administering said resource means by said healthcare-purchasing cooperative or cooperatives;
a process of utilizing said resource means for optimally benefit said consumers, buyers, physicians and healthcare professionals;
a process of facilitating physicians and healthcare professionals to optimally concentrate on providing the best healthcare goods and services to said consumers and buyers;
a process of maximizing said physicians' and healthcare professionals' healthcare-service productivity;
a process of collecting, tracking, recording, sorting and analyzing the dispensations and utilizations of healthcare goods and services;
a process of collecting, recording, sorting and analyzing the outcomes of said healthcare goods and services;
a process of collecting, recording, sorting and analyzing said dispensations, utilizations and outcomes relate to a physician or healthcare professional;
a process of collecting, recording, sorting and analyzing said dispensations, utilizations and outcomes relate to a physician or healthcare professional relative to cohort physicians, healthcare professionals or peers;
a process of ranking a physician or healthcare professional relative to peers as a function of said dispensations, utilizations, performance, efficiency, treatment and preventive medicine means, modes and outcomes;
a process of sorting physicians or healthcare professionals based on said dispensations, utilizations, performance, efficiency, treatment and preventive medicine means, modes and outcomes;
a process of facilitating the access of consumers, buyers and healthcare-purchasing cooperatives to a physician or healthcare professional based on said ranking and sorting as a function of said dispensations, utilizations, performance, merits, efficiency, treatment and preventive medicine means, modes and outcomes;
a process of proportionately compensating a physician or healthcare professional based on said consumers' utilizations of said goods and services, the physician's or healthcare professional's dispensations of said goods and services and said data relating to dispensations, utilizations, performance, merits, efficiency, treatment and preventive medicine means, modes and outcomes; and
the use of the computer softwares, programs, computers and the Internet or World Wide Web to link said consumers, buyers, physicians and healthcare professionals.
